(19) United States
(12) Patent Application Publication
(10) Pub. No.: US 2005/0197721 A1
(43) Pub. Date: Sep. 8, 2005

(54) Control of exposure energy on a substrate

(76) Inventors: Yung-Cheng Chen, Jhubei City (TW); You-Wei Shen, Hsinchu City (TW); Chun-Ming Hu, Hsinchu City (TW)

Correspondence Address: DUANE MORRIS, LLP;IP DEPARTMENT, ONE LIBERTY PLACE, PHILADELPHIA, PA, 19103-7396, US

(21) Appl. No.: 10/783,495

(22) Filed: Feb. 20, 2004

(51) Int. Cl. G05B 13/02

(52) U.S. Cl. 700/45

(57) ABSTRACT

A method for controlling exposure energy on a wafer substrate, with a feedback process control signal of wafer thickness critical dimension, and with a feed forward process control signal of a compensation amount that compensates for thickness variations of an interlayer of the wafer substrate.

### FIELD OF THE INVENTION

The invention relates to semiconductor circuit manufacturing. More particularly, the invention relates to a system and method for controlling critical dimension, CD, for focus of exposure energy applied to a substrate on a semiconductor wafer.

### BACKGROUND

To control CD, critical dimension, for a poly-gate, transistor gate oxide, the exposure energy of lithography tools needs to change with changes in wafers that have different wafer thicknesses and different surface topographies. Both the thickness and the surface topography of each wafer are produced by a pre-process of STI, shallow trench isolation. The exposure energy (or exposure dose) is the amount of light energy supplied to a resist. The exposure energy along with several other variables are critical in lithography to meet critical submicron resolution requirements, which affect the quality of the end product.

CMP, chemical mechanical planarization, is a polishing process step that removes surface material to planarize a top layer of semiconductor material on a semiconductor wafer. CMP produces a smooth, planar polished surface on the planarized film.

For example, CMP is performed on an STI layer, shallow trench isolation layer, fabricated of a material, including, and not limited to, a nitride, for example, silicon nitride. A poly-gate layer, or substrate, is applied on the planarized STI material, for example, a poly film, followed by planarizing STI by CMP. When wafers of numerous manufacturing lots are polished and planarized by CMP, the lots will have lot-to-lot wafer thickness fluctuations or variations. Further, the manufacturing lots will have lot-to-lot wafer topography fluctuations or variations.

When a photolithography exposure process step is performed on the poly film, the exposure energy applied on the poly film determines the CD of poly-gate. The manufacturing lot fluctuations in wafer thickness and topography of the STI also affect the poly-gate CD, and thus, affect the appropriate exposure energy applied on the poly film. Prior to the invention, an organic BARC, bottom anti-reflective coating, on the poly film was used to counterbalance for wafer thickness and topography fluctuations. However, an organic BARC has the disadvantage of being highly priced. Further, the BARC tends to cause other side effects, including, an increased etching bias during a selective etching process step. A less expensive inorganic BARC is preferred, instead of the more expensive organic BARC.

Prior to the invention, a poly-gate CD was set as the sole criteria for an advanced process control system, APC system, to control the exposure energy applied to a poly-gate layer. The poly-gate CD was obtained by measuring the CD on the photo resist image. These measurements were collected as data for a control chart that calculated the exposure energy. Then the poly-gate CD would provide feedback information for a feedback controller for run-to-run (manufacturing lot run-to-run).

This system of feed back poly-gate CD control was relied upon to control the exposure energy applied to a poly-gate layer on respective wafers of the next manufacturing lot. However, the system of feedback poly-gate CD control would be insufficient to compensate for wafer thickness and topography fluctuations on the wafers of the next manufacturing lot, which would cause fluctuations in the exposure energy applied to the poly-gate layer.

### SUMMARY OF THE INVENTION

A motivation for the present invention was to improve the system of feed back poly-gate CD control to better compensate for lot-to-lot fluctuations in thickness and topography of the wafers, to reduce fluctuations in exposure energy focused on poly-gate layers of the wafers.

The present invention relates to a discovery of the dominant factor affecting the lot-to-lot fluctuations in exposure energy. Proof of discovery of the dominant factor is described herein. Further, the present invention relates to a method and apparatus, according to which, the dominant factor controls the exposure energy that is focused on top layers of the wafers.

The method and apparatus of the invention automatically obtains a correct exposure energy of poly-gate, by a system of feedback CD control, combined with a feed forward control of STI layer thickness, which corrects for wafer to wafer thickness variations and wafer to wafer topography variations.

The pre-process effects of CMP on an STI interlayer is discovered to cause lot to lot fluctuation of exposure energy on a top layer of poly-gate. The invention is based on proof of a strong correlation of poly-gate CD with a wafer thickness and topography of a planarized STI substrate. A planarized STI substrate refers to a wafer substrate having an STI layer on which CMP has been performed.

The invention provides an advantage, to control the poly-gate CD without requiring an additional cost of organic BARC and/or CMP rework on the STI substrate. The existing system of feedback CD control, having a feedback run-to-run controller, retains its functionality and structure, and retains its role in a system of poly-gate CD control according to the invention.

Further, according to the invention, the exposure energy is controlled by compensation for the most sensitive factors affecting poly-gate CD. The STI substrate has an STI interlayer directly beneath the poly-gate top layer. The STI remaining thickness is more strongly correlated to the poly-gate CD than would be the n/k measured on the poly-gate, because the n/k measurement has a larger noise contribution, i.e., larger spurious measurement variations, from a combined stack of the poly-gate with AR coatings and other films.

The invention is modeled on the relationship of a poly-gate CD and a remaining thickness of an STI substrate, shallow trench isolation substrate, after both have been planarized by CMP. A polynomial function of the invention models the relationship of the poly-gate CD and the STI remaining thickness, resulting from STI CMP.

According to an embodiment of the invention, an APC system provides feed forward and feedback CD control. According to another embodiment of the invention, a feedback controller calculates the process error from a measured CD. According to another embodiment of the invention, a feed forward controller calculates the compensation for preprocess fluctuations or disturbance resulting from STI CMP. According to another embodiment of the invention, the feed forward controller has a user configurable, polynomial function model, which makes the polynomial function more linear, and solely linear, depending upon which configuration of polynomial coefficients are set at zero by the user.

Embodiments of the invention will now be described by way of example with reference to the accompanying drawings.

### BRIEF DESCRIPTION OF THE DRAWINGS

FIG. 1 is a graph of lot-to-lot fluctuation of poly-gate critical dimension.

FIG. 2A is a graph of CD change versus change in remaining STI thickness.

FIG. 2B a graph of CD change versus change in remaining oxide thickness.

FIG. 3 is graph of a linear function model.

FIG. 4 is a graph of a segmented linear function model.

FIG. 5 is a graph of a polynomial function model.

FIG. 6 is a diagram of a feed forward simulator.

FIG. 7 is a graph, similar to the graph of FIG. 1, disclosing feed forward models.

FIG. 8 is a diagram of an APC system of feed forward and feedback CD control according to the invention.

### DETAILED DESCRIPTION

A system of advanced process control, APC, for photolithography exposure, reliably controls the exposure energy applied to a poly-gate layer. Prior to the invention, the APC was a feedback system. A poly-gate CD was obtained by measuring the CD on the photo resist image. These measurements were collected as data for the APC that calculated the exposure energy. Then the poly-gate CD provided feedback information for a feedback controller for run-to-run (manufacturing lot run-to-run). A poly-gate CD was the sole criteria for the feedback system to control the exposure energy. The poly-gate CD was determined by wafer thickness and topography fluctuations, n/k, that were measured on the poly-gate substrate.

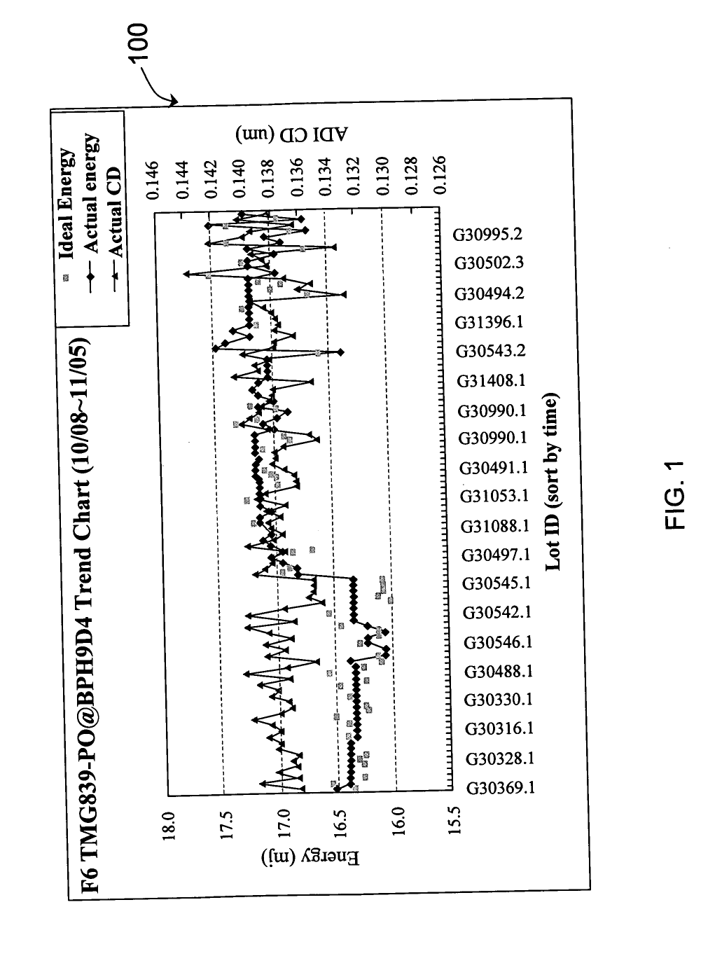

FIG. 1 discloses an example of poly-gate CD trend (100) by lot-to-lot fluctuation, indicating larger than 5 nm lot-to-lot difference for the same actual energy applied. The invention resulted from a motivation to improve the lot-to-lot fluctuation with a feed forward APC. The disclosure hereinafter describes which control parameter was selected for the feed forward APC. A study was conducted to determine the pre-process effects of STI CMP on the lot-to lot fluctuation. STI CMP refers to an STI interlayer that has been planarized by CMP. Other factors that might affect lot-to-lot fluctuation would be, errors contributed by a resist coating process step and by a developing step, errors in metrology and pre-processing, and scanner source error.

To create a feed forward APC, first, a model of feed forward APC must prove a correlation between CD and pre-process effects of STI CMP. Further, the correlation with STI CMP must provide uniformity of proof within an allowable latitude for variation within the same manufacturing lot. As disclosed hereinafter, the pre-process effects of STI CMP was proved as being the dominant factor affecting lot-to-lot fluctuation.

The results in Table 1 disclose uniformity of within-lot latitude of remaining thickness. Table 1 indicates measurements of remaining nitride remaining after planarization by CMP, and remaining oxide after planarization by CMP, for (5) five production lots of 12 wafers per lot. Thickness data of remaining nitride and remaining oxide was collected at (9) nine pre-determined sites for every wafer.

Table 1 records average, maximum and minimum measured values from the data collected at the nine predefined measurement sites on the wafers. One Sigma is used to calculate thickness uniformity within each lot. Table 1 shows the uniformity of remaining nitride and remaining oxide are 11 A⁰, Angstroms, and 47 Angstroms, respectively. The uniformity is acceptable, when compared with actual thickness targets of 870 Angstroms and 4700 Angstroms, respectively, for remaining nitride and remaining oxide, after performance of CMP. Thus, a basis is established for a feed forward thickness control parameter since no significant inconsistency is present within the same manufacturing lot of multiple wafers.

TABLE 1
UNIFORMITY OF STI CMP PERFORMANCE RESULTS

| | SNI (W1W) | | | SNI (W2W) | | | |
|---|---|---|---|---|---|---|---|
| | | Max | | | | | |
| Lot | Average (1S) | (1S) | Min (1S) | Mean | Max | Min | 1 Sigma |
| 1 | 23 | 29 | 17 | 922 | 950 | 903 | 12 |
| 2 | 24 | 27 | 17 | 936 | 958 | 906 | 15 |
| 3 | 29 | 39 | 21 | 899 | 913 | 881 | 11 |
| 4 | 23 | 33 | 15 | 884 | 895 | 872 | 6 |
| 5 | 17 | 25 | 13 | 914 | 928 | 892 | 10 |
| Average | 23 | 31 | 17 | 911 | 929 | 891 | 11 |

STI CMP Performance

| | Ox (W1W) | | | Ox (W2W) | | | |
|---|---|---|---|---|---|---|---|
| | | Max | | | | | |
| Lot | Average (1S) | (1S) | Min (1S) | Mean | Max | Min | 1 Sigma |
| 1 | 57 | 72 | 47 | 4704 | 4831 | 4608 | 62 |
| 2 | 49 | 59 | 37 | 4698 | 4792 | 4579 | 52 |
| 3 | 74 | 115 | 41 | 4625 | 4701 | 4543 | 52 |
| 4 | 62 | 98 | 33 | 4641 | 4692 | 4615 | 25 |
| 50 | 57 | 68 | 47 | 4682 | 4748 | 4611 | 43 |
| Average | 60 | 83 | 41 | 4670 | 4753 | 4591 | 47 |

### STI CMP Performance

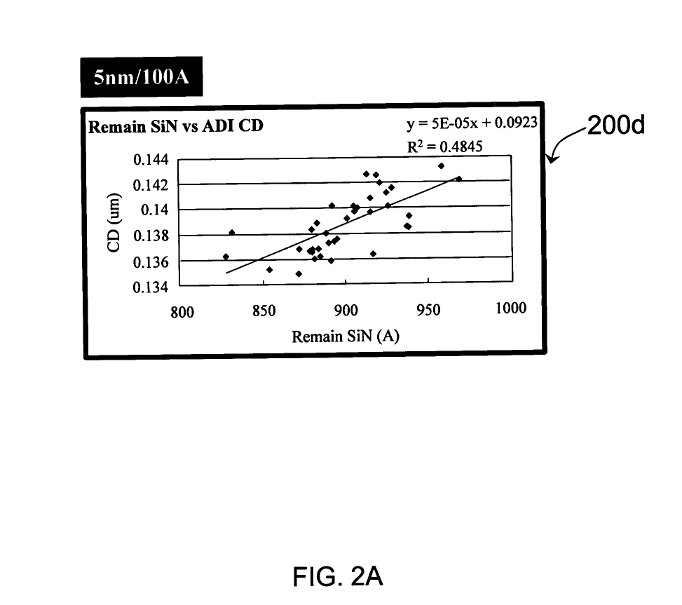

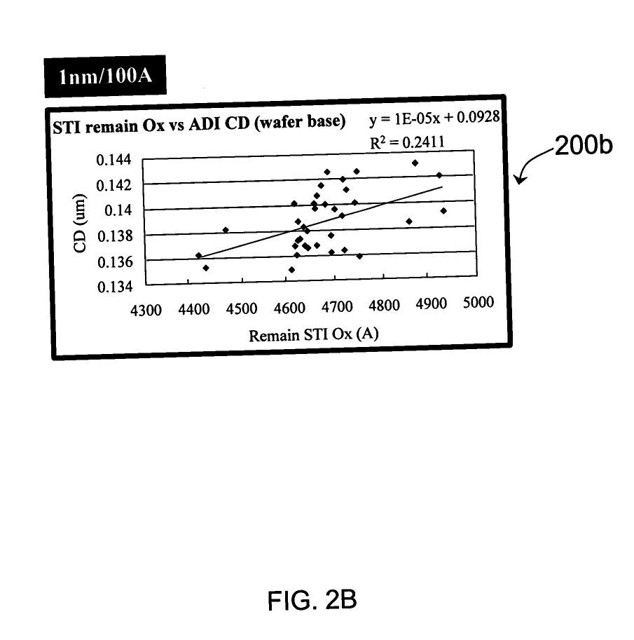

FIG. 2A is a diagram (200a) of recorded data points. The data points were established by experiment. According to the experiment, STI CMP was conducted on an STI nitride, SiN. After STI CMP, thickness data of the remaining nitride was collected at pre-determined (9) nine data sites on each of 36 wafers. Then, poly-gate film deposition and photo lithography patterning of the poly-gate film was conducted. Then, the critical dimension CD of the poly-gate was measured at the (9) nine data sites. The recorded data points represent a CD change versus a change in thickness of remaining nitride following STI CMP. In other words, the data points are indicative of a correlation of CD with the pre-processing effects of STI CMP on the nitride. Further, FIG. 2A discloses a graph obtained by linear approximation of the distribution of the recorded data points. The graph is an indicator of the strength of correlation of CD with thickness of the nitride remaining after STI CMP of the nitride.

FIG. 2B is a diagram (200b) of recorded data points. The data points were established by experiment. According to the experiment, STI CMP was conducted on an STI trench oxide, Ox. After STI CMP, thickness data of the remaining oxide was collected at pre-determined (9) nine data sites on each of 36 wafers. Then, poly-gate film deposition and photo lithography patterning of the poly-gate film was conducted. Then, the critical dimension CD of the poly-gate was measured at the (9) nine data sites. The recorded data points represent a CD change versus a change in thickness of remaining oxide following STI CMP. In other words, the data points are indicative of a correlation of CD with the pre-processing effects of STI CMP on the oxide. Further, FIG. 2B discloses a graph obtained by linear approximation of the distribution of the recorded data points. The graph is an indicator of the strength of correlation of CD with thickness of the STI trench oxide remaining after STI CMP thereof.

With reference to FIGS. 2A and 2B, the linear approximation slope of remaining nitride versus remaining oxide is calculated by the formula:
Thickness-slope [μm/A⁰]=ΔCD [μm]/Δ Remaining thickness [A⁰]

Thus, the calculated thickness slope with respect to remaining nitride thickness and remaining oxide thickness, respectively, are 5×10⁻⁵ [μm/A⁰] and 1×10⁻⁵ [μm/A⁰]. The CD changes 5 nm and 1 nm, with thickness changes of 100 A⁰ of nitride and oxide, respectively.

The RMS, root-means-square, factor (R²) was used to quantify the correlation strength between CD and remaining thickness following STI CMP. In FIG. 2A, the RMS factor is (R²=0.48), for the correlation strength of a correlation of CD with remaining nitride thickness. In FIG. 2B, the RMS factor is (R²=0.24), for the correlation strength of a correlation of CD with remaining STI trench oxide. The stronger correlation (R²=0.48) implies that the remaining nitride thickness can be used as the feed forward factor for CD control.

Due to the strong correlation, the remaining nitride thickness is adopted as a feed forward factor for poly-gate CD control. Because the relationship between thickness and CD is likely to be a non-linear swing effect, such a relationship is proposed by three different models: a linear function model, a segmented linear function model and a polynomial (third order polynomial) function model.

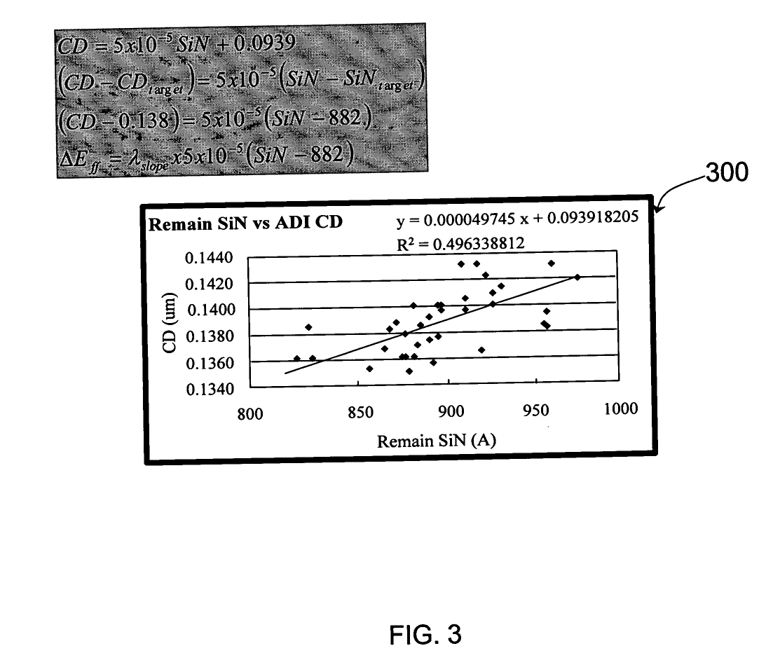

FIG. 3 discloses a linear function model (300) using a single line, of constant slope, which fits all data points of nitride thickness and CD relationship. The RMS value R²=0.496. This model can be used solely when STI CMP are controlled within tight variance limits that would indicate conformance to straight line data points.

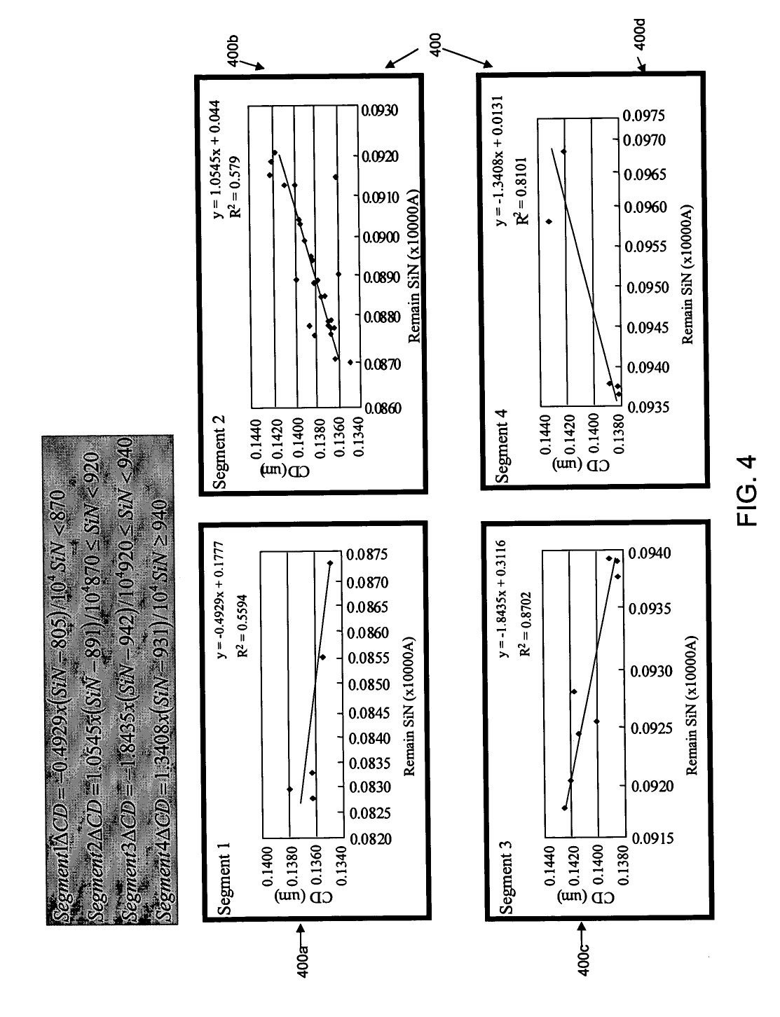

FIG. 4 discloses a segmented linear function model (400), having multiple linear models, segments (400a) and (400b) and (400c) and (400d), with different boundary conditions, which fit the data points of nitride thickness and CD relationship within the different boundary conditions. Thus, this model replicates adoption of different linear formulas for poly CD control at different thickness ranges of STI.

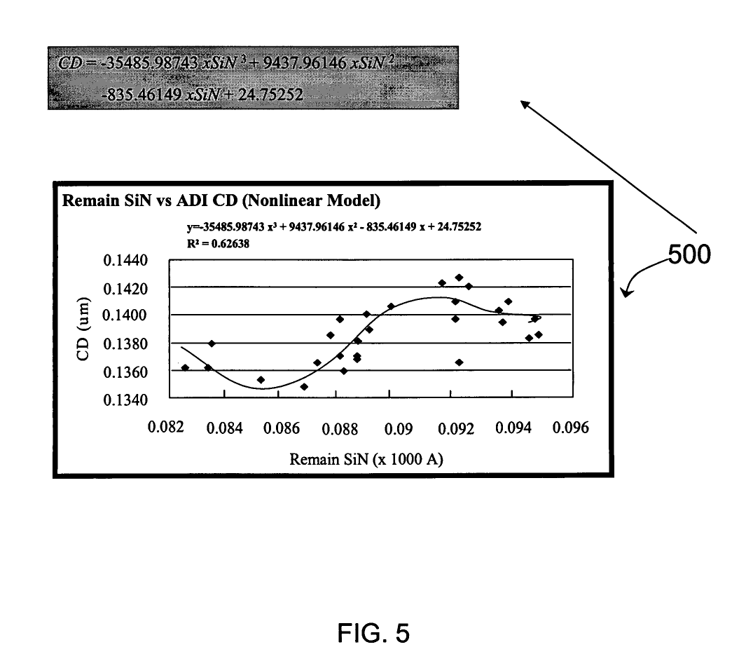

FIG. 5 discloses a polynomial function model (500), which fits the data points of nitride thickness and CD relationship. The polynomial function model describes the real relationship more exactly than the linear function model and the segmented linear function model. The error component in any of the modeled coefficients would be magnified by higher order calculations within the polynomial function. Then, the calculation error would be further magnified by metrology error in applying the calculation in a feed forward APC. Thus, a feed forward simulator examines the proposed models to compensate for a feed forward error component of the remaining nitride thickness.

A feed forward APC simulator is used to examine the proposed models. The models compensate for the feed forward error of nitride thickness. In the simulator, 37 wafers of 0.13 μm line width product with DOD (dummy OD) are used to apply this simulation, which measures (9) nine collection sites for collecting data of thickness and line CD for each wafer at post STI CMP, and post poly ADI (after developer inspection), respectively.

Further, in this simulation, the desired target CD is 0.138 μm, and the energy slope λ is 100, meaning, line CD will reduce 1 μm for a 100 milli-joule decrease in exposure energy focused by an exposure module in a scanner apparatus. The modeling coefficient, Cpk, indicates the simulation performance according to the formula:
Cpk=min {USL/3σ−CDₘₑₐₙ/3σ, CDₘₑₐₙ/3σ−LSL//3σ},
where,
   USL=0.146 and
   LSL=0.130 and
   CDₘₑₐₙ is averaged from the estimated CD of all measurement sites.

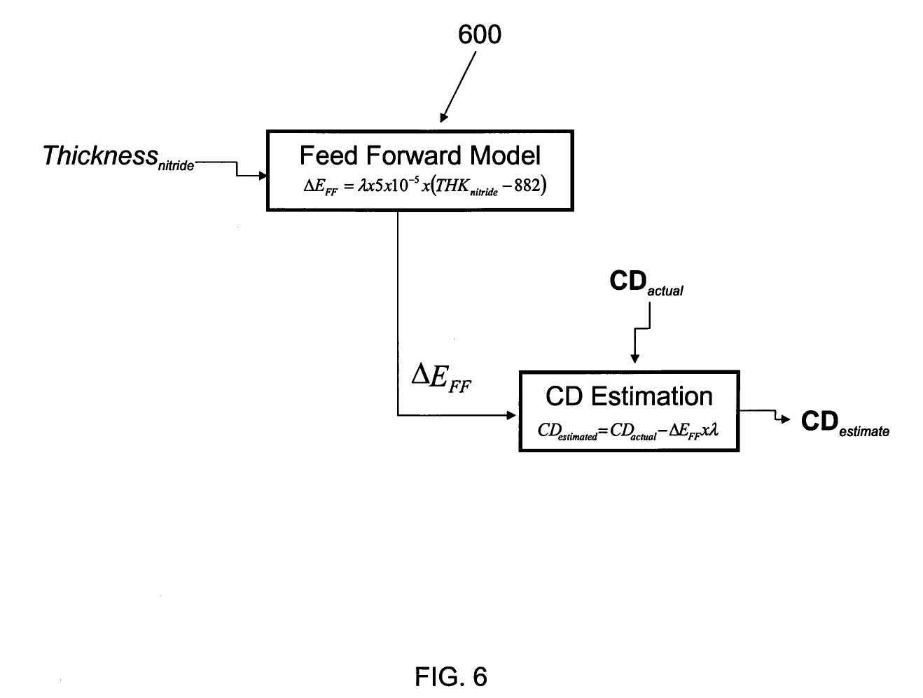

FIG. 6 discloses a diagram of the feed forward simulator (600) for the proposed linear model. The input data set, Thk_{nitride}, CD_{estimated}, are fed one after another into the simulator. The simulator final output is the estimated CD, CD_{estimated}.

As shown in Table 2, the original Cpk (the modeling coefficient without nitride thickness feed forward) is 0.76. Further, the proposed feed forward models, significantly improve the Cpk to 0.9 and 1.0, respectively. Further, the 3 Sigma are all improved, 1.2 nm, 1.8 nm, and 1.7 nm, respectively.

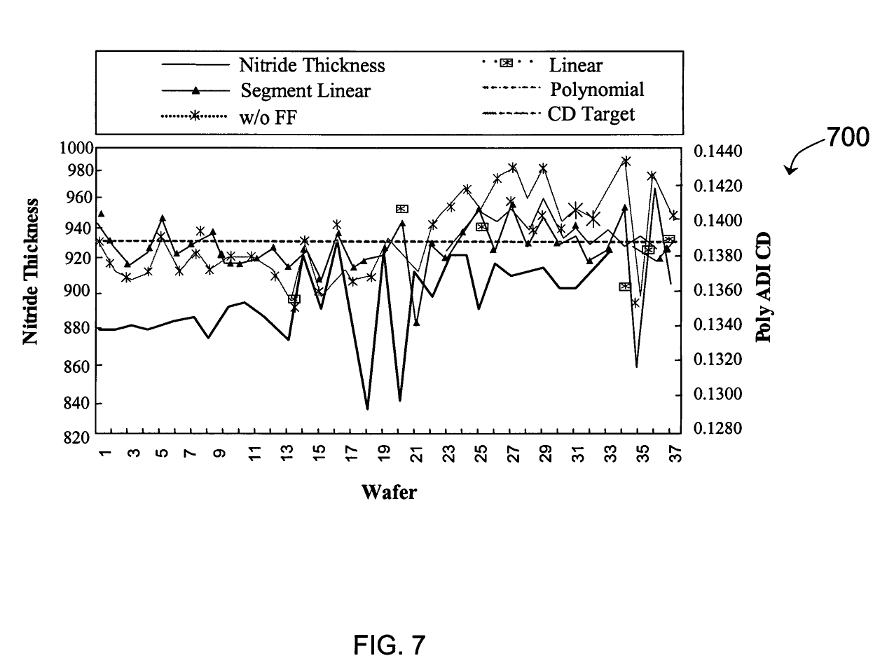

The polynomial function model has some magnified inaccuracy due to noise component in the collected data subject to higher order involution calculation. However, the feed forward energy compensates for actual nitride thickness error, as disclosed by the graph (700) of FIG. 7. Moreover, as the nitride thickness increases, the amount of improvement increases due to more aggressive compensation.

TABLE 2
SIMULATION RESULTS OF PROPOSED FEED FORWARD MODEL

| Feed | | | | Cpk | 3 sigma |
|---|---|---|---|---|---|
| Forward Model | CD Mean | 3 sigma | Cpk | Improvement | Improvement |
| None | 0.1387 | 0.0097 | 0.8 | | |
| Linear | 0.1378 | 0.0085 | 0.9 | 21% | 1.2 nm |
| Segment linear | 0.1380 | 0.0079 | 1.0 | 33% | 1.8 nm |
| Polynomial | 0.1380 | 0.0080 | 1.0 | 31% | 1.7 nm |

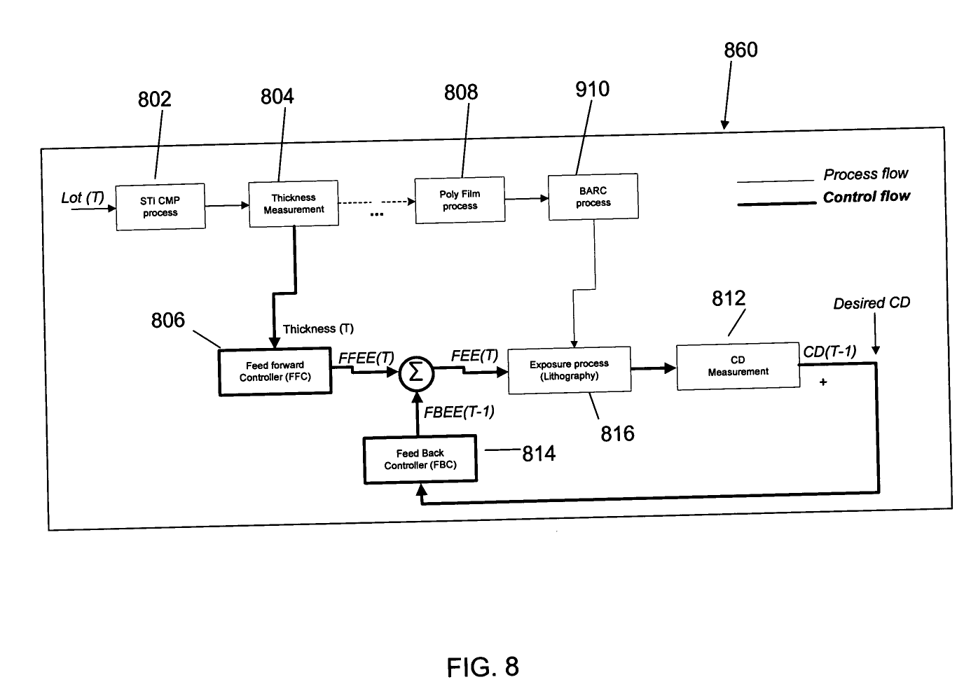

FIG. 8 discloses a feed forward APC system (800) of poly-gate CD impressed on a system of feedback control (FBC). According to the process step progression, the process begins from STI CMP for obtaining remaining STI thickness, and includes a direct measurement of poly-gate CD. The method of feed forward, combined with feedback control will now be described.

Wafer manufacturing lot T undergoes a STI CMP process (802) that is performed by a known CMP apparatus. Immediately following completion of STI CMP, the remaining nitride thickness is measured in a thickness measurement device (804). The nitride thickness measurements are automatically recorded and associated with the manufacturing lot T. The nitride thickness measurements are fed into a feed forward controller (FFC) (806).

Wafer manufacturing lot T undergoes a poly film coating process in a poly film deposition apparatus (808). Then following is an organic, bottom anti-reflective coating, BARC, in a SiON, silicon oxide nitride, deposition apparatus (810), which provides a wafer substrate having a poly-gate top layer covering an interlayer of planarized STI.

According to the invention, a polynomial function models the data for recording a relationship of poly-gate CD and remaining STI thickness. The polynomial function model is a nonlinear function, or, by setting higher order coefficients at zero, the model is converted to a linear function. The polynomial function has the formula:
y=ax⁴+bx³+cx²+dx+e
where:
   y=CD (μm), and
   x=remaining nitride thickness (A⁰).

An embodiment of the feed forward controller (FFC) (806) is user configurable. The user can set coefficients to zero in the polynomial function model, which makes the function more linear, and solely linear, depending upon which configuration of coefficients are set at zero by the user.

The method of feed forward control proceeds by transforming the compensation for disturbance, i.e., the measured remaining nitride thickness, as feed forward exposure energy (FFEE), by the FFC applying a computing algorithm:
ΔCD_{Feed Forward}=y−desired CD==ax⁴+bx³+cx²+dx+(e−desired CD)
FFEE (mj)=ω(ΔCD_{FF}) λ
where FFEE=Feed Forward Exposure Energy compensation for preprocess disturbance, and
λ=energy slope, and
0≦ω≦1.

The method of feed forward control proceeds by calculating the feedback exposure energy (FBEE) from CD measurement device (812) using data from a previous manufacturing lot, CD (T-1). The CD measurement is supplied to a feedback controller (814). Alternatively, when the system is without an FBC (814) in the process, and/or when previous lot measurements are not yet available, then an user defined exposure energy in the exposure recipe will represent FBEE.

The feed back controller (814) calculates the final exposure energy FEE (T) for an exposure apparatus (816), for example a photo lithography apparatus to perform the exposure process, for example, a process of photo lithography.

The final exposure energy FEE(T) is:
EEFF+FBEE as calculated by FFC.
FEE(T)=FFEE(T)+FBEE (T-1)
where T represents the lot “T” in the process flow.

By requiring a tightened nitride thickness specification of ±50 A⁰ the within lot nitride uniformity is assured, which determines the possibility for base feed forward APC.

Although the embodiments of the invention have been disclosed as pertaining to CD control by a poly-gate thickness and by an STI thickness, for a process control system and method, the invention pertains to CD control of any material on a wafer on which the material thickness fluctuations and/or topography fluctuations need to be compensated by CD control.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method for controlling exposure energy on a wafer substrate, comprising the steps of: controlling the exposure energy with a feedback process control signal of critical dimension, and further controlling the exposure energy with a feed forward process control signal of a compensation amount that compensates for wafer thickness variations.

2. The method of claim 1, further comprising the step of: combining the feed forward control signal with the feedback process control signal to control the exposure energy.

3. The method of claim 1, further comprising the step of: supplying the feed forward process control signal by a feed forward controller.

4. The method of claim 1, further comprising the step of: controlling the exposure energy by a feed forward control signal of an interlayer thickness measurement.

5. The method of claim 1, further comprising the step of: controlling the exposure energy by a feed forward control signal of an interlayer thickness measurement remaining after CMP thereof.

6. The method of claim 1, further comprising the step of: calculating the compensation amount according to a polynomial function with a coefficient of the function being based on a measurement of a remaining thickness of a planarized interlayer.

7. The method of claim 1, further comprising the step of: calculating the feedback process control signal of CD measurement of a top layer in a previous manufacturing lot.

8. The method of claim 1, further comprising the steps of: calculating the compensation amount according to a polynomial function with a coefficient of the function being based on a measurement of a remaining thickness of a planarized interlayer; and calculating the feedback process control signal of CD measurement of a top layer in a previous manufacturing lot.

9. The method of claim 1, further comprising the steps of: calculating the compensation amount according to a polynomial function with higher order coefficients set at zero.

10. The method of claim 1, further comprising the steps of: calculating the compensation amount according to a linear function.

11. The method of claim 1, further comprising the steps of: calculating the compensation amount according to a segmented linear function.

12. A system for controlling exposure energy on a wafer substrate, comprising:
a feed forward controller providing a feed forward control signal to an exposure apparatus based on a thickness measurement of an interlayer of the wafer substrate for controlling the exposure energy focused on a top layer of the wafer substrate, and
a feed back controller providing a feed back exposure energy control signal to the exposure apparatus based on CD measurement of a top layer of a wafer substrate of a previous manufacturing lot.

13. The system of claim 12, further comprising: a thickness measurement device providing thickness measurement data to the feed forward controller.

14. The system of claim 12, further comprising: a CD measurement device providing CD measurement data to the feedback controller.

15. The system of claim 12, further comprising:
a thickness measurement device providing thickness measurement data to the feed forward controller and
a CD measurement device providing CD measurement data to the feedback controller.

16. The system of claim 12, further comprising: a thickness measurement device providing thickness measurement data of an STI layer of the wafer substrate to the feed forward controller.

17. The system of claim 12, further comprising: a CD measurement device providing CD measurement data of a poly-gate of wafer substrates of a previous manufacturing lot.

18. The system of claim 12, further comprising:
a thickness measurement device providing thickness measurement data of an STI layer of the wafer substrate to the feed forward controller, and
a CD measurement device providing CD measurement data of a poly-gate of a previous manufacturing lot.

19. The system of claim 12 wherein,
the feed forward controller is user configurable by having one or more polynomial coefficients set to zero in a polynomial function model.

20. The system of claim 12 wherein;
the feed forward controller is user configurable by having one or more polynomial coefficients set to zero in a polynomial function model.

21. The system of claim 20, further comprising: a thickness measurement device providing thickness measurement data of an STI layer of the wafer substrate to the feed forward controller.

22. The system of claim 20, further comprising: a CD measurement device providing CD measurement data of a poly-g ate of wafer substrates of a previous manufacturing lot.
